(19) United States
(12) Patent Application Publication
(10) Pub. No.: US 2022/0185356 A1
(43) Pub. Date: Jun. 16, 2022

(54) Baby Stroller

(71) Applicant: Gricela Saavedra, Van Nuys, CA (US)

(72) Inventor: Gricela Saavedra, Van Nuys, CA (US)

(21) Appl. No.: 17/547,290

(22) Filed: Dec. 10, 2021

Related U.S. Application Data
(60) Provisional application No. 63/124,308, filed on Dec. 11, 2020.

(51) Int. Cl. B62B 9/14; B62B 7/00; B62B 9/00; B60H 1/00

(52) U.S. Cl. CPC B62B 9/142; B62B 9/147; B60H 1/00407; B62B 9/00; B62B 7/00

(57) ABSTRACT

The present invention relates to a baby stroller that provides warm and cool air to help keep an infant therein comfortable and at a desired temperature. The stroller also includes a solar panel disposed on a sunshade canopy for absorbing solar energy and converting same into electrical energy. The sunshade canopy includes a plurality of vents disposed therethrough for venting warm and cool air. The stroller includes a transparent or translucent protective cover attached to the sunshade and child seat for shielding the infant and protecting the infant from debris, germs, and inclement weather. The stroller includes a storage space housing a battery and a fan motor. The stroller provides capability of controlling blowing of warm and cool air using control buttons disposed on the stroller, using a remote control, and/or a computer implemented application.

### CROSS-REFERENCE TO RELATED APPLICATION

The present application claims priority to, and the benefit of, U.S. Provisional Application No. 63/124,308, which was filed on Dec. 11, 2020 and is incorporated herein by reference in its entirety.

### FIELD OF THE INVENTION

The present invention relates generally to the field of baby strollers. More specifically, the present invention relates to an improved infant stroller that is configured to provide warm and cool air to an infant lying in the stroller. The stroller can include a transparent or translucent protective cover for protecting the infant from debris, germs and inclement weather, while also providing an enclosed space therein. A sunshade of the stroller includes a solar panel for absorbing and converting solar energy into electrical energy, and the converted energy is used for providing warm and cool air. An integrated battery stores electrical energy and a USB port is also provided for recharging the battery. Accordingly, the present disclosure makes specific reference thereto. Nonetheless, it is to be appreciated that aspects of the present invention are also equally applicable to other like applications, devices and methods of manufacture.

### BACKGROUND

By way of background, infants and young babies are required to be carried or transported by parents or caretakers for as long as they needed to go places, and different cultures have devised ingenious methods to ease the burden of bearing the weight of a small child on long, or even short walks. Thus, a stroller or other hand-pushed vehicle used for carrying babies and young infants has become a necessity. Conventional strollers are usually designed to enable babies to lie on their backs or to seat babies and infants, and make parents' daily activities with a baby or small child much easier and less tiring.

In conventional strollers, a hood or sunshade is provided which is supported by semi-rigid members to cover the head and face of the child. However, in such cases, only a small portion of the head and face of the child is covered while the remaining portion of the body is continuously exposed to sunlight. Further, the child is exposed to winds, and flying debris while being in the stroller, which is unsafe for the child as any flying material in winds can injure the child. Individuals, therefore have to cover the child using a blanket or carry the child in their arms. The blanket can accidentally cover the face of the child which can be fatal for the child and carrying the child in ones' arms can be laborious, tiresome and painful for the parents.

Standard strollers do not provide any temperature regulating to soothe the child sitting in a stroller. Thus, in hot weather and in bright sunlight, the child may become heated, stressed, and anxious and may desire a cooler temperature. Similarly, in cold temperatures, heating is desired by the child which is not possible in current strollers.

Standard strollers do not provide space or slots to place or store adult conveniences and a parent is required to carry a phone, umbrella, cup or any other personal item in their hands or their bag which is discomforting and inconvenient for the parent. Parents desire a stroller that can provide space for storing parents' convenience items.

Therefore, there exists a long felt need in the art for an improved stroller for babies/infants that can protect a child lying or sitting in the stroller from sunlight, wind and inclement weather. There is also a long felt need in the art for a baby stroller that can provide an air conditioning mechanism. Additionally, there is a long felt need in the art for a child stroller that can provide heat to the child in the stroller for protection from cold. Moreover, there is a long felt need in the art for an improved baby stroller that can provide several adult convenience attachments. Further, there is a long felt need in the art for a child stroller that is lightweight, portable and able to roll easily over any type of terrain. Further, there is a long felt need in the art for a baby stroller device that protects a child in the stroller from harmful airborne particles. Finally, there is a long felt need in the art for an improved baby stroller that provides maximum protection from sunburn and inclement weather, while keeping the child safe, warm, cool and protected as desired.

The subject matter disclosed and claimed herein, in one embodiment thereof, comprises an infant stroller apparatus. The stroller features a sunshade canopy, the canopy includes a plurality of air vents for selectively blowing warm or cool air and a protective transparent or translucent cover is attached to the sunshade and extending to cover a child lying on a child seat therebelow, wherein the cover protects the child from weather and germs. An illumination source provides illumination of the infant and a solar panel absorbs solar energy and converts same into electrical energy. The stroller also features several adult convenience attachments such as a cup holder, a phone holder and an umbrella attachment.

In this manner, the child stroller of the present invention accomplishes all of the forgoing objectives and provides users with a stroller that features a protective transparent or translucent barrier for protecting the child from debris, sunburn (i.e. direct sunlight) and inclement weather. A built-in battery and charging system provides power for the heating and cooling system to keep the child safe and relaxed. A user's personal and essential items such as a phone and a tumbler/bottle are also easily placed in the stroller enabling a smooth and comfortable ride for both the child in the stroller and the parent/user pushing the stroller.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an infant stroller apparatus. The infant stroller apparatus is designed to offer maximum protection for an infant against inclement weather and harmful airborne particles while providing a comfortable environment and temperature to the infant. The stroller further comprising a sunshade in the form of a canopy attached to a frame, wherein the sunshade includes a plurality of air vents for blowing warm and cool air, a protective transparent or translucent cover attached to the sunshade and extending to cover a child lying on a child seat therebelow, wherein the cover protects the child from weather and germs, an illumination source for providing illumination of the infant, exterior surface of the sunshade having a solar panel disposed thereon for absorbing solar energy and converting same into electrical energy, an integrated battery for storing the electrical energy, a fan motor for selectively providing warm or cool air, a plurality of control buttons disposed on handle portion of the stroller for activating or deactivating blowing of warm or cool air, a front leg and a pair of rear legs having casters for pushing the stroller over any type of terrain, a USB port for recharging the battery using an external power supply, a phone holder for holding a smartphone, and a cup holder for holding a cup or tumbler.

A baby temperature monitor is further configured to wirelessly couple with a remote control enabling a user to remotely control blowing of warm or cool air.

In yet another embodiment, the stroller apparatus includes an umbrella attachment on the handle that can be folded and the direction of the umbrella can also be adjusted.

In yet another embodiment, the canopy is extendable or retractable and is configured to protect a portion of a child therebelow, such as the face of the infant lying in the stroller.

The subject matter disclosed and claimed herein, in another embodiment thereof, comprises a remotely-controlled infant stroller. The infant stroller includes a sturdy climate controlled stroller communicatively coupled to a computer-implemented application installed in an electronic device. The sturdy climate controlled stroller is configured to provide warm and cool air through vents or fans disposed on the sunshade wherein the air is provided by a fan motor. The computer-implemented application is configured to transmit wireless instructions for controlling blowing of warm and cool air for providing a comfortable temperature to the child or infant sitting or lying in the stroller. The application is also configured to control an umbrella attachment of the stroller and extension or retraction of the sunshade.

In yet another embodiment, the electronic device can be one or more of a smartphone, a tablet, a smartwatch or a remote control unit.

In yet another embodiment, a collapsible and solar-powered baby stroller is disclosed. The baby stroller includes a solar panel on the exterior surface of a canopy for absorbing solar power and converting same into electrical energy, the electrical energy is stored in an integrated battery and is used for illuminating an LED light disposed on a transparent or translucent protective cover of the stroller. The battery also provides power to a fan motor for providing warm and cool air which is blown through vents or fans disposed in the canopy. The stroller includes a temperature monitor for monitoring ambient temperature, the temperature monitor actuates the fan motor for automatically blowing warm or cool air based on the detected ambient temperature.

In yet another embodiment, the transparent or translucent cover is removable, and can be fastened to the child seat for protecting the infant or child lying in the stroller.

It should be appreciated that the infant stroller apparatus of the present invention is a novel stroller that provides selectively both warm and cool air to an infant and thus provides a consistent and comfortable temperature. The transparent or translucent cover protects the child from the debris, germs and inclement weather while enabling a parent to view the child continuously.

The baby stroller of the present invention is adaptable with a low cost of manufacture with regard to both materials and labor, and which accordingly then results in low prices of sale to the consuming public, thereby making such baby stroller economically available to the buying public.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an infant stroller apparatus of the present invention in accordance with the disclosed architecture;

FIG. 2 illustrates a perspective view of the baby stroller of FIG. 1 showing connection of battery and air vent control buttons in accordance with the disclosed architecture;

FIG. 3 illustrates a perspective view showing use of a remote control for controlling the sunshade, umbrella attachment and the fan motor of the baby stroller of the present invention in accordance with the disclosed architecture;

FIG. 4 illustrates a perspective view showing another variant of the baby stroller of the present invention in accordance with the disclosed architecture; and

FIG. 5 illustrates a schematic view of wireless communication between the baby stroller and a computer-implemented software application installed in a handheld electronic device in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an improved stroller for babies/infants that can protect a child lying or sitting in the stroller from sunlight, wind and inclement weather. There is also a long felt need in the art for a baby stroller that can provide an air conditioning mechanism. Additionally, there is a long felt need in the art for a child stroller that can provide heat to the child in the stroller for protection from cold. Moreover, there is a long felt need in the art for an improved baby stroller that can provide several adult convenience attachments. Further, there is a long felt need in the art for a child stroller that is lightweight, portable and able to roll easily over any type of terrain. Further, there is a long felt need in the art for a baby stroller device that protects a child in the stroller from harmful airborne particles. Finally, there is a long felt need in the art for an improved baby stroller that provides maximum protection from sunburn and inclement weather, while keeping the child safe, warm, cool and protected as desired.

The present invention, in one exemplary embodiment, is a novel remotely-controlled infant stroller. The infant stroller is communicatively-coupled to a computer-implemented application installed in an electronic device or to a physical remote-control unit. The stroller is configured to provide warm and cool air through vents or fans disposed on sunshade wherein the air is produced by a fan motor. The computer-implemented application is configured to transmit wireless instructions for controlling blowing of warm and cool air for providing a comfortable temperature to the child or infant sitting or lying in the stroller. The application is also configured to control an umbrella attachment of the stroller and extension or retraction of the sunshade.

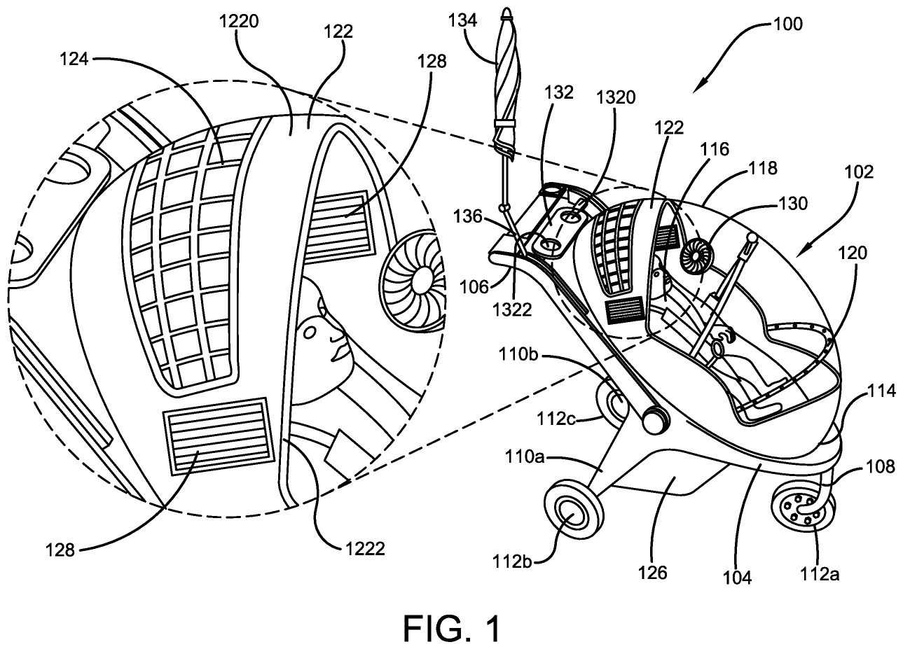

Referring initially to the drawings, FIG. 1 illustrates a perspective view of one potential embodiment of the infant stroller apparatus of the present invention in accordance with the disclosed architecture. FIG. 1 shows several advantageous features of the present invention, however as will be described below, the invention can be provided in several shapes, sizes, combinations of features and components, and varying numbers and functions of the components. The infant stroller 100 of the present invention is designed to offer maximum protection for a child against inclement weather and harmful airborne particles while providing adequate temperature control. More specifically, the stroller 100 includes a frame 102, the frame 102 includes a base 104 and a handle portion 106. The base 104 and the handle 106 are pivotally-attached, thereby enabling a pivotal movement of the handle 106 relative to the base 104. The base 104 includes a front leg 108 and a pair of rear legs 110a,110b. Each leg 108,110a,110b includes, respectively, a wheel or caster referenced by numerals 112a,112b,112c. The wheels 112a,112b,112c are durable and sturdy and enable a parent to push the stroller safely and comfortably 100 over any terrain and surface. Each wheel 112a,112b,112c may have treads on the outer surface that enable a grip on the terrain to prohibit slipping.

A child seat 114 is placed on the base 104 that is ergonomically-styled for a baby or infant 116 to conveniently lie down. The child seat 114 includes a flexible and removable transparent or translucent cover 118 that is configured to protect the baby 116 from debris, rain, germs and other weather elements. The cover 118 includes a coating or tinting configured to protect the baby 116 from harmful ultraviolet rays of sunlight. The transparent or translucent cover 118 can have toys or other amusing items 120 for the baby 116 selectively attached thereto.

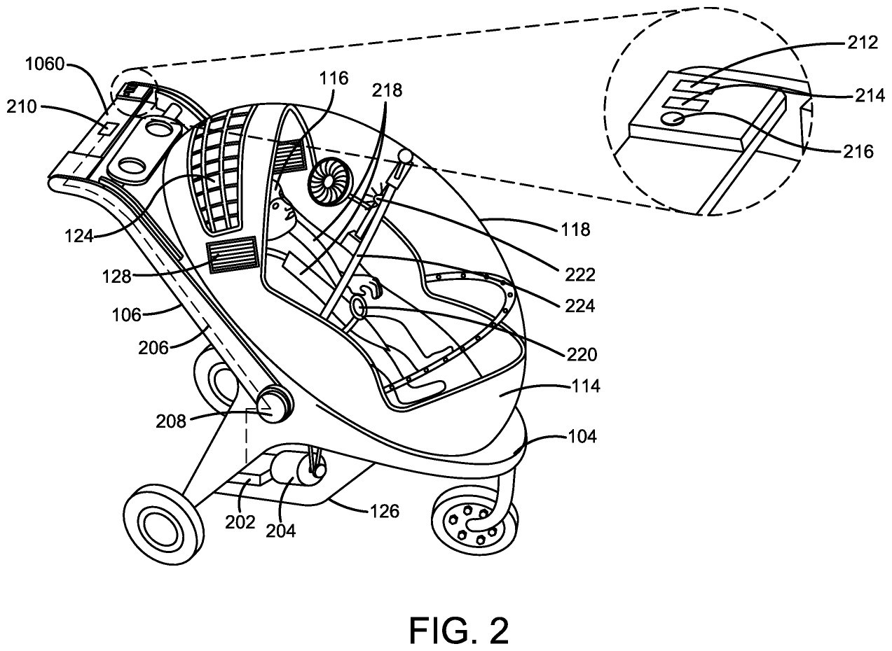

An extendable sunshade 122 of the seat 114 is configured to protect the face of the child 116 from direct sunlight. The sunshade 122 can be extended or retracted as per the desire of a parent or caretaker pushing the infant 116 in the stroller 100. The sunshade 122 is in the form of a canopy and obviates the use of a blanket to protect the infant from the sun. A weather-resistant solar-panel 124 is disposed on the exterior surface 1220 of the sunshade 122 and is configured to absorb solar energy and convert same into electrical energy. The solar panel 124 may be laminated with a transparent or translucent layer of weatherproof plastic material. The electrical energy formed by the solar panel 124 is stored in an integrated battery (as best shown in FIG. 2) of the stroller 100 wherein the battery is placed in the storage space 126. The storage space 126 is preferably positioned underneath the frame base 104 and is secured through an access door.

The translucent cover 118 is removably-attached to the trailing edge 1222 of the sunshade canopy 122. The cover 118 can be rolled over the canopy when the infant 116 is placed or taken out from the stroller 100. The cover 118 is also secured to the edges of the baby seat 114 for providing an adequate protection shield to the infant 116. The cover 118 is configured to provide ventilation to the child 116 along with the vents 128.

The sunshade 122 includes a plurality of vents 128 that are used for venting out warm or cool air. The warm air is used for maintaining an elevated temperature for the baby 116 and the cover 118 maintains a temperature difference between the outside ambient temperature and the interior temperature of the seat 114. Similarly, the cool air can be used in a hot climate for keeping the child 116 at a lower temperature. The air is produced using a fan motor (shown in FIG. 2) placed in the storage space 126. There can be a plurality of vents 128 positioned on the sunshade 122. An additional fan 130 can also be placed to blow air on face of the child 116 in order to alleviate sweating.

The handle portion 106 includes a cupholder tray 132 that is integrally or removably-attached to the handle 106. The cupholder tray 132 includes at least a cupholder slot 1320 and a phone holder slot 1322. These are used for storing user conveniences/devices and obviate the need of a user such as a parent to carry a phone, a bottle, and other things in their hand or bag. The stroller 100 includes an umbrella attachment 134 for further convenience when operating the stroller. The umbrella is comprised of thermal material, is flexible, and can be adjusted in any direction. The umbrella 134 is removably-connected to the handle portion 106 using the connector 136 which can be a mechanical screw type fastener. The height of the umbrella 134 can also be adjusted as per requirements of a user. The frame 102 can be made from BPA and phthalate free plastic. The plastic outer layer 102 is splash proof and is unbreakable.

Here, the solar panel 124 is installed on the exterior 1220 of the sunshade 122. That is, in order to prohibit the sunlight from shining directly on the infant 116 in the stroller 100 as in the summer when the sunshine is strong, the solar energy can be effectively harnessed when the sunshade 122 is fully opened. The solar panel 124 can be embedded into an exterior surface 1220 or can be sewn to the sunshade 122. Also, the solar panel 124 is flexible and can be extended or retracted.

FIG. 2 illustrates a perspective view of the baby stroller 100 of FIG.1 showing the connection of a battery and air vent control buttons in accordance with the disclosed architecture. As stated, an advantage of the stroller 100 of the present invention is that it includes an internal battery 202 and a fan motor 204 stored in the storage space 126 that makes the stroller 100 able to provide warm and cool air along with an illumination. The battery 202 can be an Li-Ion or nickel battery and is configured to store electrical energy converted from the solar energy by the solar panel 124. The solar panel 124 and the battery 202 are connected through a wired mechanism (not shown) that is disposed within a frame of the stroller 100. The battery 202 is also connected to a USB port 210 through a wired circuit 206. The USB port 210 enables the battery 202 to be charged using a conventional USB power supply and is useful in cases the solar energy is not continuously available. For repairing the wired circuit, the connector 208 of the handle 106 and the body 104 can be removed and the connector 208 is further configured to pivotally attach the handle 106 and the body 104.

The fan motor 204 is integrally-coupled to the battery 202 and is configured to produce warm or cool air as per the requirements of a user. Operation of the fan motor 204 is controlled using a plurality of control buttons disposed on the horizontal member 1060 of the handle 106. The control button 212, when activated or pushed, enables the fan motor 204 to produce cool air and the cool air is blown through the vents 128. An air conditioning mechanism of the fan motor is activated upon pushing the control button 212 and enables to produce cool air. Similarly, for producing warm air from the fan motor 204, a warm control button 214 is activated by a user. The warm control button 214 enables production of the warm air and blows same through the vents 128. A master control button 216 is configured to enable or disable the fan motor 204.

For providing illumination in the stroller 100, an illumination source 222 such as an LED light, is disposed on a strap 224 positioned laterally across the transparent or translucent cover 118. The LED light 222 is used for providing illumination to and on the child 116 and is particularly useful in low light, dark areas, or at night. The LED light 222 is configured to receive electrical power from the battery 202 and can be a single color or multicolor LED light.

For providing additional security and safety to the child 116, a safety belt 218 is disposed on the seat 114. The safety belt 218 is secured using a buckle 220, thereby, wrapping the child 116 in a secure position. The belt 218 is soft, flexible and can be extended or retracted to accommodate children of various sizes. Preferably, the belt 218 is made from an elastic nylon material.

It should be appreciated that all the electronic components such as illumination source 222, fan motor 204, and others requiring electrical power for their function are coupled to the battery 202 through wired circuits. The wired circuit can be common or separate for each component and is disposed within the frame 102.

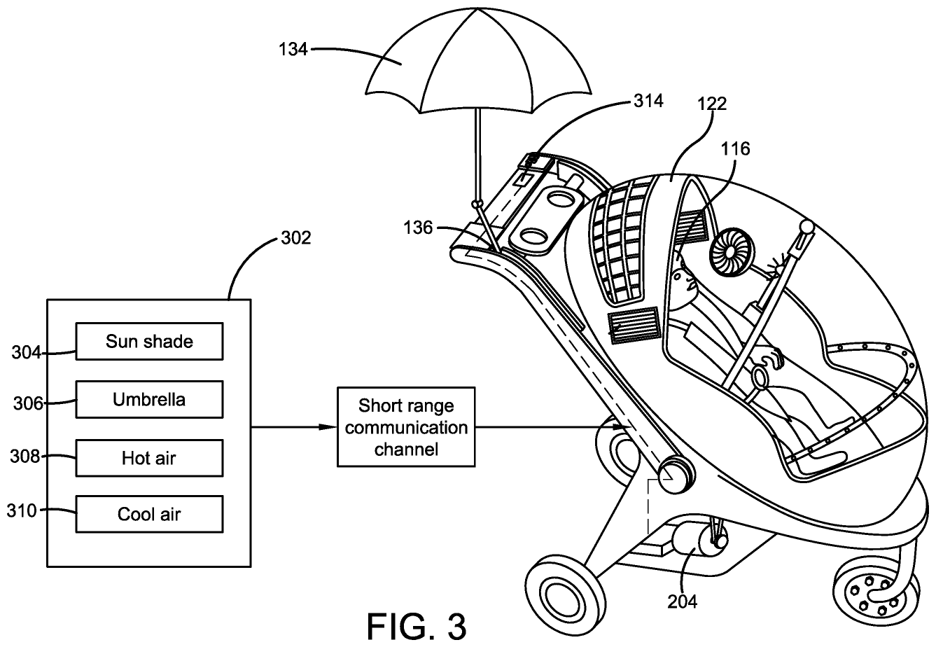

FIG. 3 illustrates a perspective view showing use of a remote control for controlling sunshade, umbrella attachment, and the fan motor of the baby stroller 100 of the present invention in accordance with the disclosed architecture. The remote control 302 is commercially available with the stroller 100 and is used for remotely controlling some of the functions of the stroller 100. The remote control 302 uses a short-range wireless communication channel 312 for transmitting wireless instructions to the stroller 100. The remote control 302 includes a plurality of control buttons for controlling functions of the stroller 100. As shown, a sunshade control button 304 is used for extending or retracting the sunshade 122. The sunshade 122 in an extended position shields a portion of the child 116 from the sun's rays.

The umbrella control button 306 is used for folding or adjusting the direction of the umbrella attachment 134. The umbrella attachment connector 136 is actuated using the umbrella control button that enables folding or unfolding the umbrella 134. For providing warm air to the child 116, the warm air control button 308 is used. This enables the fan motor 204 to activate a heating mechanism for producing warm or hot air and blow same through the vents. Similarly, for providing cool air to the child 116, the cool air control button 310 is used. This enables the fan motor 204 to activate a cooling mechanism for producing cool air and blow same through the vents disposed on the sunshade 122. The device itself can also be folded for easy storage.

It should be appreciated that, for wireless communication, the stroller 100 includes a short-range communication module 314 configured to provide a wireless communication channel for communication with the remote control 302.

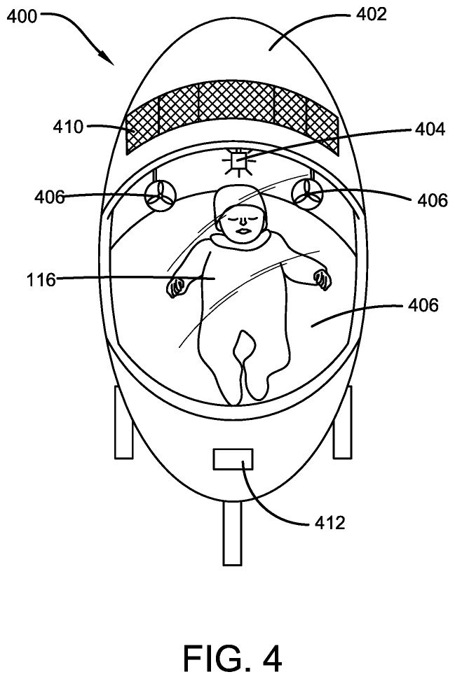

FIG. 4 illustrates a perspective view showing another variant of the baby stroller of the present invention in accordance with the disclosed architecture. In the present embodiment, the stroller 400 includes a plurality of fans 406 instead of vents for providing warm or cool air to the child 116. An inner surface of the sunshade 402 includes the fans 406 and the LED light 404. The fans 406 and the light 404 are powered by the integrated battery in a manner similar to the other embodiments of the present invention and thus is not described for brevity purposes. The stroller 400 of the present embodiment includes the transparent or translucent cover 408 and the solar panel 410 for absorbing solar power and for converting same into electrical energy. All other features such as several adult convenience attachments like a cup holder, a phone holder, and an umbrella attachment are also disposed on the stroller 400.

The stroller 400 includes a temperature controller (i.e. thermostat) 412 that detects ambient or surrounding temperature. Further, the temperature controller 412 automatically activates the blowing of warm or cool air from the fan to maintain a desired temperature for the child 116. The temperature controller 412 can also be integrated in other embodiments of the present invention.

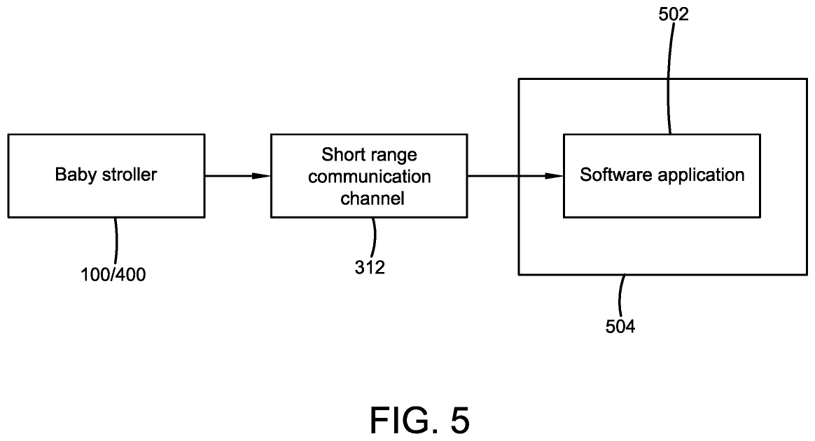

FIG. 5 illustrates a schematic view of wireless communication between the baby stroller and a computer-implemented software application 502 installed in a handheld electronic device in accordance with the disclosed architecture. An advantage of the stroller 100/400 is that it can be wirelessly operated using the software application 502 installed in the electronic device 504 such as a smartphone, or a smartwatch. The wireless channel 312 is used for communication between the stroller 100 and the application 502. The stroller 100 can be configured in the software application 502 that enables a user such as a parent or caretaker to remotely operate the stroller 100.

The wireless communication channel 312 may be of any local area network (LAN), metropolitan area network (MAN), wide area network (WAN), a public data network (e.g., the Internet), short range wireless network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), Zigbee, Wi-Fi Direct, wireless LAN (WLAN), Bluetooth®, mobile ad-hoc network (MANET), and the like, or any combination thereof. Wi-Fi enables the electronic device 504 to remotely control and operate the stroller 100.

The software application 502 provides a plurality of control options to control the sunshade, the fan operations, and umbrella attachment of the stroller. The application 502 can be updated periodically to include new features and can be downloaded using the Internet. The software application 502 also provides a remote user the ability to rotate the direction of umbrella of the stroller 100/400.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “baby stroller”, “infant stroller apparatus”, “stroller”, “Climate controlled Stroller”, and “modified stroller” are interchangeable and refer to the infant stroller apparatus 100,400 of the present invention.

Notwithstanding the forgoing, the infant stroller apparatus 100,400 of the present invention can be of any suitable size and configuration as is known in the art without affecting the overall concept of the invention, provided that it accomplishes the above stated objectives. One of ordinary skill in the art will appreciate that the size, configuration and material of the infant stroller apparatus 100,400 as shown in the FIGS. are for illustrative purposes only, and that many other sizes and shapes of the infant stroller apparatus 100,400 are well within the scope of the present disclosure. Although the dimensions of the infant stroller apparatus 100,400 are important design parameters for user convenience, the infant stroller apparatus 100,400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A baby stroller for controlling the environment of a baby therein, the baby stroller comprising:
a frame including a base and a handle portion, wherein said base and said handle are pivotally attached for pivotal movement of said handle relative to said base;
a front leg and a pair of rear legs each including a caster mounted to a terminal end for rolling said stroller;
a baby seat mounted to said base, wherein said seat includes a flexible and removable translucent cover for protecting a baby thereunder;
wherein said cover shields the baby thereunder; and
wherein said cover and said seat form a substantially enclosed temperature controlled space.

2. The baby stroller of claim 1, wherein said cover is tinted.

3. The baby stroller of claim 1, wherein said seat further includes a flexible sunshade for protecting a portion of the baby from direct sunlight.

4. The baby stroller of claim 3, wherein said sunshade is extendable and retractable.

5. The baby stroller of claim 4, wherein said sunshade includes a plurality of vents to provide ventilation to the baby thereunder.

6. The baby stroller of claim 5, wherein said sunshade includes a solar panel on an exterior surface of said sunshade to absorb solar energy and convert same into electrical energy.

7. The baby stroller of claim 6, wherein said electrical energy is stored in a battery.

8. The baby stroller of claim 7, further comprising a fan motor for selectively supplying warm air or cold air to said enclosed temperature controlled space.

9. The baby stroller of claim 8, further comprising a fan for circulating said warm air or said cold air in said enclosed temperature controlled space.

10. A baby stroller for controlling the environment of a baby therein, the baby stroller comprising:
a frame including a base and a handle portion, wherein said base and said handle are pivotally attached for pivotal movement of said handle relative to said base;
a baby seat mounted to said base, wherein said seat includes a flexible and removable translucent cover for shielding a baby thereunder;
wherein said cover and said seat form a substantially enclosed temperature controlled space;
a fan motor for selectively supplying warm air or cold air to said enclosed temperature controlled space; and
a fan for circulating said warm air or said cold air in said enclosed temperature controlled space.

11. The baby stroller of claim 10, wherein said cover is tinted.

12. The baby stroller of claim 10, wherein said seat further includes a flexible sunshade for protecting a portion of the baby from direct sunlight.

13. The baby stroller of claim 12, wherein said sunshade is extendable and retractable.

14. The baby stroller of claim 13, wherein said sunshade includes a plurality of vents to provide ventilation to the baby thereunder.

15. The baby stroller of claim 14, wherein said sunshade includes a solar panel on an exterior surface of said sunshade to absorb solar energy and convert same into electrical energy.

16. The baby stroller of claim 15, wherein said electrical energy is stored in a battery.

17. A baby stroller for controlling the environment of a baby therein, the baby stroller comprising:
a frame including a base and a handle portion, wherein said base and said handle are pivotally attached for pivotal movement of said handle relative to said base;
a baby seat mounted to said base, wherein said seat includes a flexible and removable translucent cover for shielding a baby thereunder;
wherein said cover and said seat form a substantially enclosed temperature controlled space;
a fan motor for selectively supplying warm air or cold air to said enclosed temperature controlled space; and
a thermostat integrated with said fan motor and said enclosed temperature controlled space, wherein said thermostat can be set to maintain a desired temperature.

18. The baby stroller of claim 17, wherein said seat further includes a flexible sunshade for protecting a portion of the baby from direct sunlight; and
further wherein said sunshade includes a solar panel on an exterior surface of said sunshade to absorb solar energy and convert same into electrical energy.

19. The baby stroller of claim 18, wherein said electrical energy is stored in a battery.

20. The baby stroller of claim 19, further comprising a USB port for charging said battery.
